(19) United States
(12) Patent Application Publication
(10) Pub. No.: US 2003/0122104 A1
(43) Pub. Date: Jul. 3, 2003

(54) Liquid replacement systems

(75) Inventors: Thomas J. Blakemore, Flossmoor, IL (US); Yu-Sen Chen, Naperville, IL (US); Dennis Kelly, Chicago, IL (US)

Correspondence Address: STOUT, UXA, BUYAN & MULLINS LLP, 4 VENTURE, SUITE 300, IRVINE, CA, 92618, US

(73) Assignee: Dober Chemical Corporation, Midlothian, IL (US)

(21) Appl. No.: 10/365,097

(22) Filed: Feb. 12, 2003

Related U.S. Application Data
(63) Continuation-in-part of application No. 09/781,842, filed on Feb. 12, 2001.
(60) Provisional application No. 60/356,421, filed on Feb. 12, 2002.

(51) Int. Cl. C02F 5/02

(52) U.S. Cl. 252/175

(57) ABSTRACT

A liquid replacement system is provided for introducing additives to an open recirculating system or a closed loop boiler water system in a controlled manner. The liquid replacement system comprises a make-up line and an additive system disposed therein. A make-up liquid enters into the make-up line where the additive system is structured to provide a controlled release of an additive to the make-up liquid, and the make-up liquid carries the additives into the open recirculating system or a closed loop boiler water system. The liquid replacement system allows for controlled release of additive components to the open recirculating system or the closed loop boiler water system, thereby delivering an effective concentration of additive components over an extended period.

This application is a continuation-in-part of application Ser. No. 09/781,842, filed Feb. 12, 2001, the disclosure of which is incorporated in its entirety herein by reference, and this application claims the benefit of application Ser. No. 60/356,421, filed Feb. 12, 2002, the disclosure of which is incorporated in its entirety herein by reference.

### BACKGROUND OF THE INVENTION

Traditionally, additives such as anti-foulants, anti-scaling agents, corrosion inhibitors, buffering and pH agents, microbiocides and the like are added directly to the solutions of aqueous systems as needed to prevent scale deposition, corrosion of metal surfaces and similar fouling of the aqueous systems, as well to maintain proper pH levels. As used herein, an aqueous system may include, without limitation, a cooling system, an open recirculating cooling water system, a closed loop boiler water system and an engine cooling system.

In certain aqueous systems, it is important to maintain a steady level of additives. For example, the presence of microbiocides is especially important in an aqueous system such as cooling systems employed in cooling towers. Cooling towers usually maintain a cooling system for a considerable length of time. Typically, such cooling systems do not have sufficient aeration and exposure to sunlight to prevent microbial, especially bacterial and fungal, growth. In particular, many cooling systems use fill composed of beads of synthetic polymer or other materials, in order to extend the amount of heat exchange surface area. This type of construction greatly aggravates the problem of microbiological growth, since it provides an ideal physical environment for the propagation of troublesome microbes. If left untreated, such microorganisms may flourish and produce colonies extensive enough to give rise to problems of biofilm blockage of heat exchange surfaces, as well as clogging of the components of the water transporting apparatus used in operating the aqueous system.

Various methods of introducing additives to an aqueous system have been developed. For instance, a solid additive material may be added directly to the aqueous system which dissolves in the aqueous system. However, this method cannot maintain a steady concentration level of additive within the system. Initially, there would be a high level of the additives released into the system, and within a short time the additives are depleted. Additionally, a significant draw back of this method is the danger of overdosing the system with particular additives which are initially released. The overdosing is dangerous in that it can result in erosion and corrosion problems.

Pump systems have been developed to provide for a more steady and controlled release of additives into an aqueous system, such as an open recirculating system. For example, a commonly used system to introduce additives into an open recirculating system comprises a monitor, liquid additives and a pump. The monitor checks the concentration of the additive concentration in the open recirculating system and activates the pump to pump more additives into the open recirculating system when the additive levels are low.

The use of monitors and pumps to provide for controlled release of additives may require a high degree of maintenance. Furthermore, the existing pump systems may expose workers to harm, such as splashing of chemicals. A need still exists for a more effective system to provide for a controlled release of additives.

### SUMMARY OF THE INVENTION

The present invention features a system which provides for controlled release of additives into an aqueous system, for example open recirculating system, without having to rely on monitors and pumps. Furthermore, the present invention provides for a safer system and method of providing additives to an aqueous system.

In accordance with the present invention, a liquid replacement system for providing additives to an open recirculating system is provided. The liquid replacement system comprises a make-up line and an additive system disposed therein. The additive system is structured to provide a controlled release of an additive to a make-up liquid flowing through the make-up line. The make-up liquid carries the additives into the open recirculating system.

Further in accordance with the present invention, the make-up line fluidly connects with a source line. The make-up liquid originates from the source line and at least a fraction of the make-up liquid enters into the make-up line. In one embodiment, the fraction of the make-up liquid passing through the make-up line is controlled by a valve. For example, a valve located in the source line or make-up line may be adjusted to allow a specific flow. In one embodiment, less than about 50%, for example less than about 10%, of the make-up liquid originating from the source line enter into the make-up line.

Still further in accordance with the present invention, the flow rate of the make-up liquid flowing through the make-up line is slower than the flow rate of the make-up liquid flowing through the source line.

Still further in accordance with the present invention, the source line further fluidly connects with an additional make-up line. In one embodiment, about less than about 90%, for example about 50%, of the flow of the make-up liquid originating from the source line enter into the additional make-up line. In one embodiment, the flow rate of the make-up liquid flowing through the additional make-up line is slower than the flow rate of the make-up liquid flowing through the source line.

Still further in accordance with the present invention, the additive system comprises a container having an additive composition therein. Furthermore, the container is structured to allow for the make-up liquid to come into contact with the additive composition. In one embodiment, the additive composition comprises an additive component and a controlled release component.

Still further in accordance with the present invention, the controlled release component functions to delay the release of additives of an additive composition. In one embodiment, the controlled release component may comprise a polymer of any type, provided that the polymer is substantially effective in providing a controlled release of the additives of the additive composition.

Still further in accordance with the present invention, the liquid replacement system comprises a source line, a first make-up line, a second make-up line and an additive system, including an additive component, disposed in the first make-up line. The source line fluidly connects with the first make-up line and the second make-up line. The make-up liquid passes from the source line and enters into at least one of the first make-up line and the second make-up line. The additive system is structured to provide a controlled release of the additive component to the make-up liquid passing through the first make-up line, which carries the additive component into the open recirculating system or the closed loop boiler water system.

Each and every feature described herein, and each and every combination of two or more of such features, is included within the scope of the present invention provided that the features included in such a combination are not mutually inconsistent.

### BRIEF DESCRIPTION OF THE DRAWINGS

FIG. 1 shows an embodiment of the liquid replacement system 10 wherein the additive filled make-up liquid in the make-up line 12 feeds directly into the open recirculating system 18.

FIG. 1b shows a make-up liquid entering into the container, mixing with the additive component, and carrying out the additives into the make-up line.

FIG. 2 shows an embodiment of the liquid replacement system 110 wherein the additive filled make-up liquid in the make-up line 112 feeds into the additional make-up line 124.

FIG. 2b is a schematic illustration of a liquid replacement system 10b coupled to a cooling tower 118b.

FIG. 3 shows an embodiment of the liquid replacement system 210 wherein the additive filled make-up liquid in the make-up line 212 feeds directly into the open recirculating system 218 and also feeds into the additional make-up line 224 through a shunt 228.

FIG. 4 shows a system presently being used in the industry to provide additives to an open recirculating system 318. A pump 377 is required for pumping additives into the make-up line 381.

FIG. 5 shows one embodiment of the additive system 414 being disposed in a make-up line 412. The make-up fluid 422 flows through the containers 416, pick up the additive therein, and the carries the additive into an aqueous system.

### DETAILED DESCRIPTION OF THE INVENTION

The present invention relates to a liquid replacement system capable of providing additives to an aqueous system in a controlled manner, without the use of monitors and/or pumps. Preferably, the aqueous system is an open recirculating system, such as an open recirculating cooling system, for example, a cooling tower. In a broad embodiment, the liquid replacement system comprises a make-up line and an additive system disposed therein. A make-up liquid enters into the make-up line where the additive system is structured to provide a controlled release of an additive to the make-up liquid, and the make-up liquid carries the additives into the open recirculating system.

In one embodiment, the make-up line fluidly connects with a source line, where the source line provides for at least a fraction of the make-up liquid that enters into the make-up line. The source line may also fluidly connect with an additional make-up line, where at least a fraction of the make-up fluid enters into the additional make-up line. In one embodiment, the source line fluidly connects to more than one additional make-up line, for example two or three additional make-up lines.

A source line comprises a liquid conduit, for example a tube, carrying make-up liquid to replenish the open recirculating system. In one embodiment, the make-up liquid comprises a liquid derived from a municipal water source. The source line terminates and becomes a make-up line and/or additional make-up line. In one embodiment, the source line terminates and become make-up line. In one embodiment, the source line terminates and becomes make-up lines A and B. In one embodiment, the source line terminates and becomes a make-up line and two additional make-up lines.

The make-up line and the additional make-up line differ in that advantageously the make-up line has an additive system disposed therein, and the additional make-up line may or may not have an additive system disposed therein.

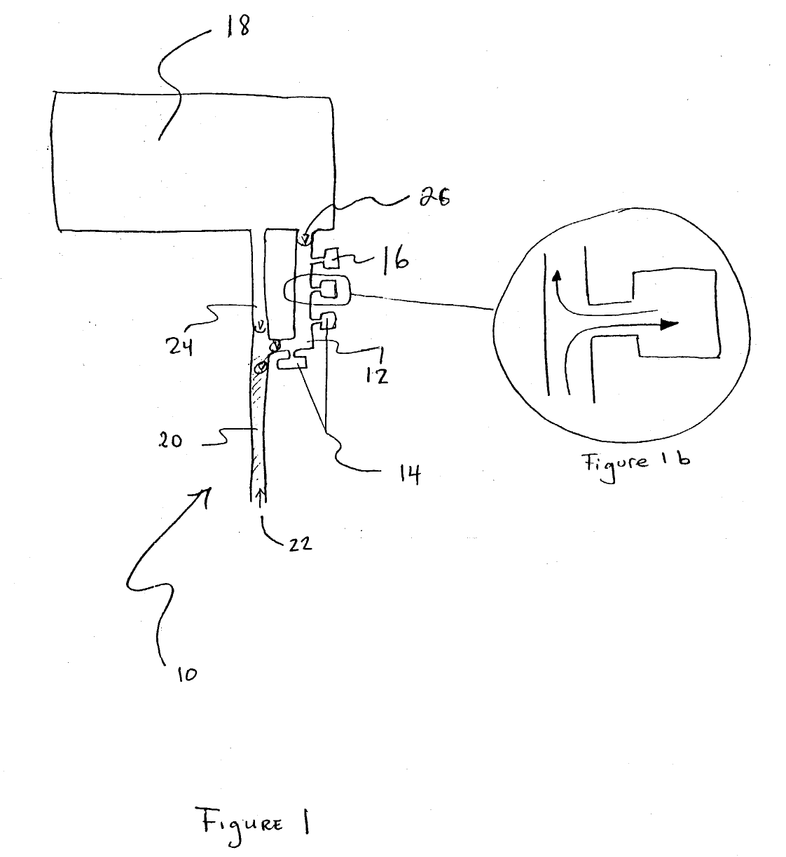

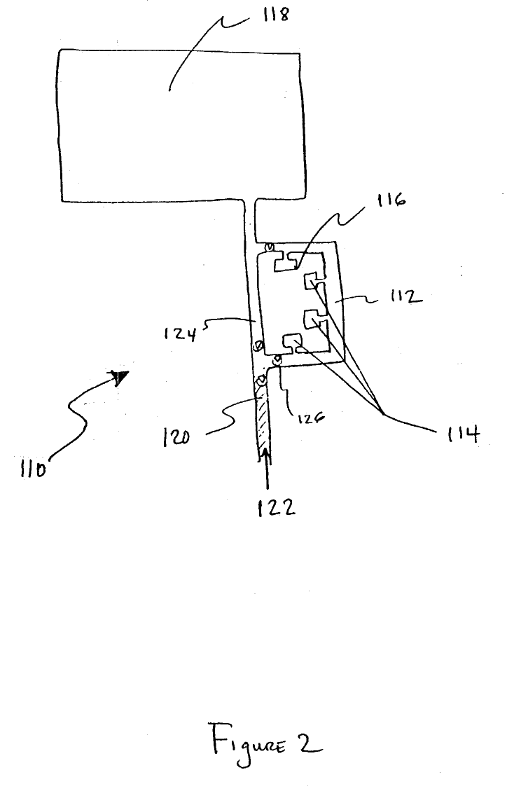

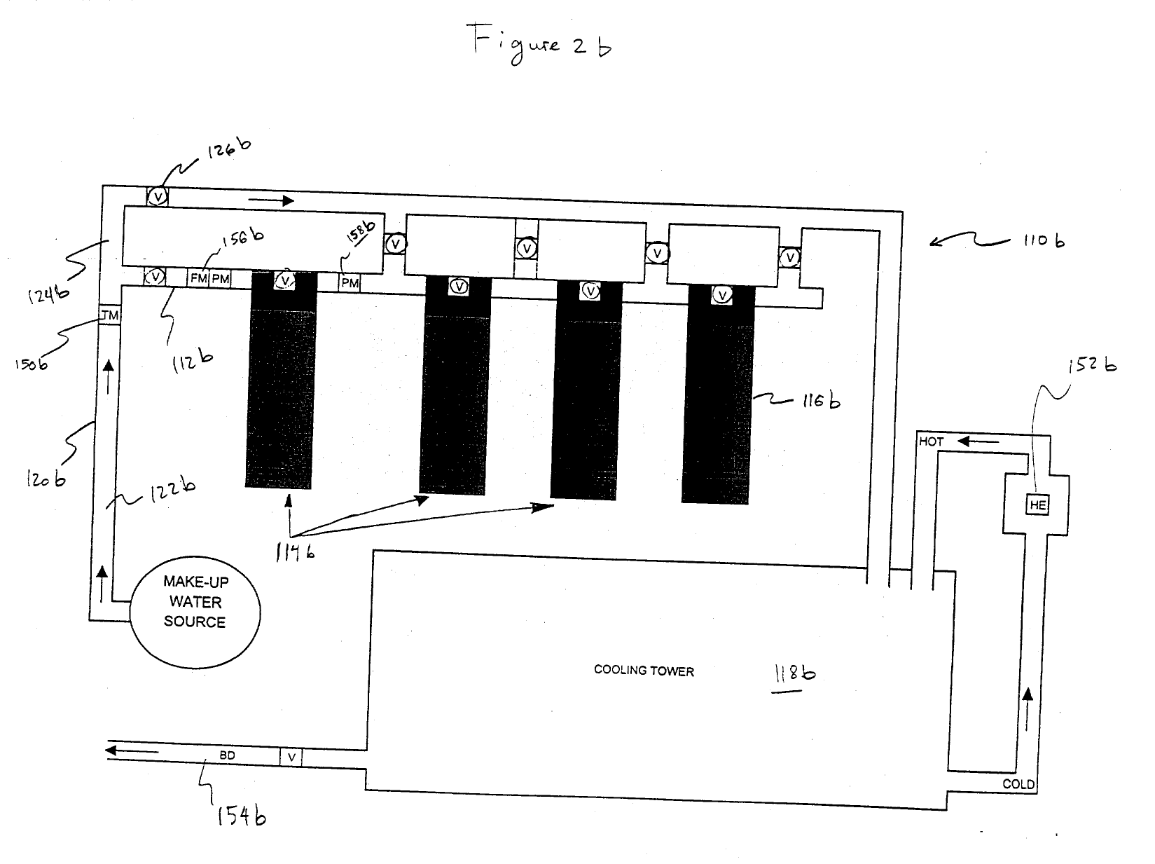

In one embodiment, the make-up line comprises a liquid conduit, for example a tube, where an additive system may be fluidly connected. In one embodiment, the make-up line ends at the point where it feeds into the open recirculating system. For example, the make-up line ends at the point where it feeds into the open recirculating system, as shown in FIG. 1. In one embodiment, the make-up line ends at the point where it feeds into an additional make-up line, as shown in FIG. 2.

The additional make-up line comprises a water conduit, for example a tube, which begins where the source line ends. In one embodiment, the additional make-up line does not have an additive system disposed therein. In one embodiment, the additional make-up line comprises an additive system disposed therein, similarly to the make-up line. Preferably, the additional make-up line terminates at the point where it feeds into the open recirculating system, for example, see FIGS. 1, 2 and 3.

In one embodiment, the liquid replacement system comprises one make-up line and multiple additional make-up lines. In one embodiment, the make-up line and the additional make-up line are at least partially interconnected, for example via a shunt. Furthermore, a check valve may be incorporated into one or more of the make-up lines to prevent contamination of potable water by back flow.

FIG. 1 shows a liquid replacement system 10. The make-up line 12 is adaptable for attaching an additive system 14 comprising a container 16. The make-up line feeds directly into an open recirculating system 18. The source line 20 feeds the make-up liquid 22 into the make-up line 12 and the additional make-up line 24. The additional make-up line begins where the source line 22 ends and feeds directly into the open recirculating system 18. Valves 26 are placed at various locations in the source line 20, make-up line 12 and additional make-up line 24 to control the flow of the make-up fluid 22.

FIG. 2 shows a liquid replacement system 110. The make-up line 112 is adaptable for attaching an additive system 114 comprising a container 116. The source line 120 feeds the make-up liquid 122 into the make-up line 112 and the additional make-up line 124. Downstream, the make-up line 112 feeds into the additional make-up line 124. The additional make-up line begins where the source line 120 ends and feeds directly into the open recirculating system 118. Valves 126 are placed at various locations in the source line 120, make-up line 112 and additional make-up line 124 to control the flow of the make-up fluid 122. In one embodiment, the containers may be attached to the make-up line using common NPT pipe fittings. NPT pipes are well known by one of ordinary skill in the art.

FIG. 2b shows a liquid replacement system 110b. The make-up line 112b is adaptable for attaching an additive system 114b comprising a container 116b. The source line 120b feeds the make-up liquid 122b into the make-up line 112b and the additional make-up line 124b. Downstream, the make-up line 112b feeds into the additional make-up line 124b. The additional make-up line begins where the source line 120b ends and feeds directly into the open recirculating system 118b. Valves 126b are placed at various locations in the source line 120b, make-up line 112b and additional make-up line 124b to control the flow of the make-up fluid 122b. A temperature sensor/meter 150b (TM) may be placed, for example, in the source line. Also, a flow meter 156b (FM) may be placed, for example, in the make-up line to detect the flow rate therein. Furthermore, a pressure sensor/meter 158b (PM) may be placed, for example, in the make-up line to detect the pressure therein. The cooled liquid in the cooling tower may be recycled or eliminated. For example, the cool liquid from the cooling tower is recycled by passing through a heat exchanger 152b (HE), capturing the heat, and flowing back into the cooling tower as hot/warm liquid. The cooled liquid may be eliminated, for example, through a blowdown drain 154b (BD).

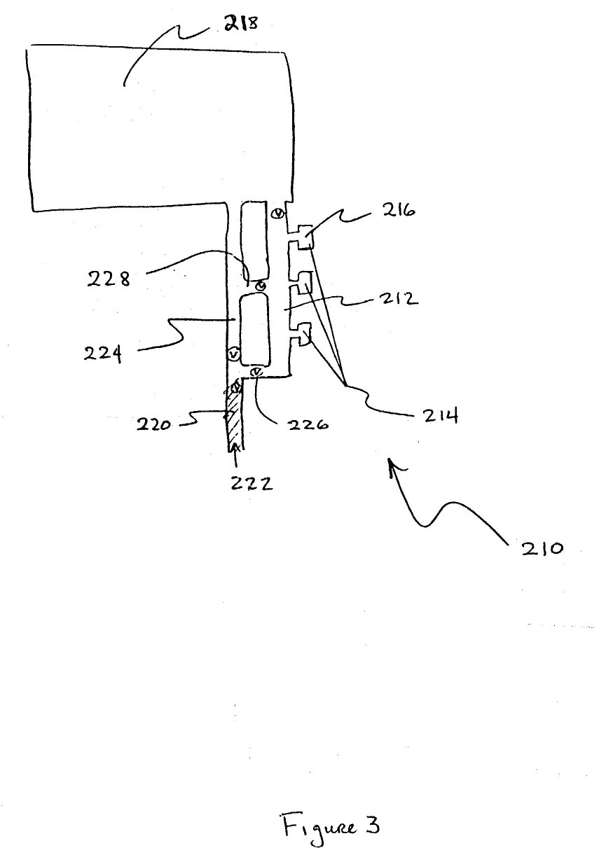

FIG. 3 shows a liquid replacement system 210. The make-up line 212 is adaptable for attaching an additive system 214 comprising a container 216. The make-up line feeds directly into an open recirculating system 218. The source line 220 feeds the make-up liquid 222 into the make-up line 212 and the additional make-up line 224. The additional make-up line begins where the source line 22 ends and feeds directly into the open recirculating system 218. The make-up line also feeds into the additional make-up line via a shunt 228 Valves 226 are placed at various locations in the source line 220, make-up line 212, additional make-up line 224 and shunt 228 to control the flow of the make-up fluid 222.

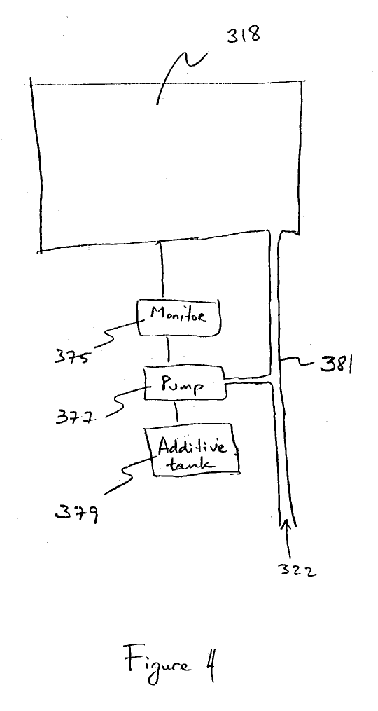

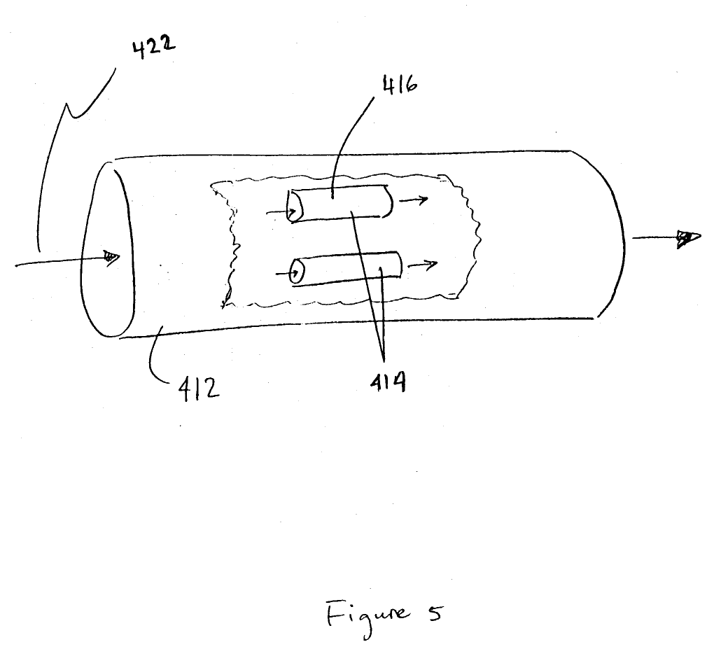

FIG. 4 shows a system which is presently being used to provide for additives into the open recirculating system 318. The presently used system comprises a monitor 375 which checks for the level of additives in the open recirculating system. When appropriate, the monitor triggers a pump 377 to pump additives (from the additive tank) into a make-up line 381. The make-up line 381 feeds the make-up fluid 322 and the additives into the open recirculating system 318.

The fraction of the make-up fluid originating from the source line which enters into the make-up line and/or additional make-up line is controlled by a valve, for example a solenoid valve. For example, the fraction of the make-up fluid originating from the source line entering into the make-up line and additional make-up line may be controlled by valves located in the make-up line and additional make-up line, respectively.

In one embodiment, less than about 50%, preferably less than about 10%, of the make-up liquid originating from the source line enters into the make-up line. In one embodiment, the flow rate of the make-up liquid flowing through the make-up line is slower than the flow rate of the make-up liquid flowing through the source line. For example, the flow rate of the make-up liquid through the source line is about 1 gallon/min to about 100 gallon/min, and the flow rate through the make-up line is about 1 gallon/min to about 10 gallon/min. In a preferred embodiment, the flow rate of the make-up liquid through the make-up line is about 3 gallon/min. Preferably, a sufficient volume of make-up liquid flows through the make-up line per minute to provide for the desired amount of additive into the open recirculating system.

In one embodiment, less than about 90%, for example, about 50%, of the flow of the make-up liquid originating from the source line enters into the additional make-up line. In one embodiment, the flow rate of the make-up liquid flowing through the additional make-up line is slower than the flow rate of the make-up liquid flowing through the source line. For example, the flow rate of the make-up liquid through the source line is about 1 gallon/min to about 100 gallon/min, and the flow rate through the additional make-up line is about 50 gallon/min to about 90 gallon/min. If the additional make-up line also comprises an additive system therein, an adequate volume of make-up liquid should flow through to provide for the desired amount of additive into the open recirculating system.

In one embodiment, the volume of the make-up liquid entering into an open recirculating system is about equal to the rate of loss in volume in the open recirculating system. The loss in volume may be through evaporation, drift and/or blowdown. For example, in a 100 ton open recirculating system, about 2-10 gallons of liquid are lost per minute; thus, the volume of make-up liquid entering into the open recirculating system should be about the same to compensate for the volume loss.

In one embodiment, the make-up line is a first make-up line, and the additional make-up line is a second make-up line.

The additive system disposed in the make-up line is structured to provide controlled release of an additive to the make-up liquid passing through the make-up line. For example, an additive system in accordance with the present invention comprises at least one container, or canister, which is at least partially filled with an additive composition. Furthermore, the container may be fluidly connected to the make-up line to allow the make-up fluid to flow into the container to mix with the additive composition and to flow out of the container carrying additive components into the open recirculating system.

In one embodiment, the containers comprise a housing and an inner cartridge. The housing may be constructed out of, for example high density polyethylene (HDPE), polypropylene (PP), polyvinyl chloride (PVC), stainless steel, yellow metal alloys and the like. The inner cartridge fits inside the outer housing. The inner cartridge may be constructed from the same or different material as the outer housing. In one embodiment, the dimensions of the inner cartridge is about 4.5 inch by about 20 inch. Other sizes are available and suitable. The container may be attached to the make-up line (and/or additional make-up line) through a pipe, for example a PVC, copper and/or galvanized pipe NPT pipe. The housing may be fitted with female pipe threads at both ends. The thread is usually about 0.75 to about 1.5 NPT.

The housing and the replaceable cartridges may be purchased from Flowmatic Systems, in Dunnellon, Fla.; Harmscon Filtration Products, in Palm Beach, Fla.; or Cole Parmer Instrument., in Vernon Hills, Ill.

In one embodiment, a container for a 100 ton cooling tower may be purchased from Flowmatic with the following specifications: filter housing #FH10000WWlPR 4½″×20″, empty cartridge # GAC BB20 REW 4½″×20″. The cartridge can hold about 8 pounds of coated tablets, wherein the size of each coated tablet may be about ⅜″×⅜″. A typical release rate for such container is about 12 ppm in 60 minutes (about 50 ppm total at 4 cycles of concentration) or about 0.21 ppm/minute at a flow rate of 2 gallon per minute through the housing.

In one embodiment, each container is configured to release about 0.1 to about 10 ppm of an additive at about 2 to about 4 gallon/min. In a preferred embodiment, each container is configured to release about 0.5 to about 5 ppm of an additive at about 3 gallon/min. In a more preferred embodiment, each container is configured to release about 1 ppm of an additive at about 3 gallon/min.

The number of containers and the release rate of the additives by the container may be modified to meet a particular specification. For example, to increase the release rate of additives, more containers may be added to the make-up line, and vice versa. Also, the degree to which the additive compositions are packed in the containers may be adjusted to vary the release rate of additives. For example, a looser packing of the additive compositions allows for a higher release rate, and vice versa.

An additive composition of this invention may be any composition which releases additives in a liquid media, for example a make-up fluid. Preferably, the additive composition releases additives slowly over a period of time, in a controlled manner. It is believed that the use of additive compositions is safer over the use of pumps. For example, the use of additive compositions avoids the splashing of chemicals which is commonly associated with a pump system.

In one embodiment, the additive composition comprises a controlled release component and an additive component. The controlled release component provides for controlled release of the additive component. Furthermore, the controlled release component may comprise any material, for example, one or more suitable polymers, which is effective to delay the release of an additive. . Controlled release components may comprise polymers disclosed in, for example, Mitchell et al U.S. Pat. No. 5,741,433; Mitchell et al U.S. Pat. No. 6,010,639; Brown U.S. Pat. No. 5,803,024; Hudgens et al U.S. Pat. No. 5,662,799 and Dobrez et al U.S. Pat. No. 4,842,731; Characklis U.S. Pat. No. 4,561,981; Blakemore et al U.S. patent application 09/539,914, the disclosures of which are incorporated in their entirety herein by reference.

In one embodiment, the additive composition comprises a matrix constructed from the controlled release component, for example, a water soluble or water insoluble component, and the additive component.

In one embodiment, the additive composition comprises a core comprising the additive component and a controlled release component substantially surrounding, or coating, the core. In one embodiment, the coating is water soluble. In one embodiment, the coating is water insoluble.

In a preferred embodiment, the additive composition comprises a core containing a water-soluble additive component and a controlled release component coating encapsulating said core which enables the slow release of the additive component into the open recirculating cooling water system. Any type of coating conventionally known in the art which provides controlled-release properties may be used in the present invention.

In a preferred embodiment, the coating is a polymer commercially available as a water dispersion. More preferably, the polymer dispersion has the following properties:

1. Low viscosity: The polymer dispersion should be of a low to medium viscosity. When the viscosity is too high, it would become impossible to pump the polymer dispersion through a coating system. This would cause the line and spray gun to become plugged. Also, in this case, the droplets of polymer dispersion would be too thick and difficult to lose moisture. They would not have the desired level of dryness before they reach the tablet surface. Therefore, the polymer may not form a good and homogeneous coating.

It should be noted that reducing the viscosity of a polymer dispersion through dilution with water is not always a viable solution. Often the dilution leads to changes of physical properties for the polymer dispersion and renders the polymer not appropriate for coating applications.

2. Low film forming and glass transition temperatures: Every polymer has its own characteristic film forming temperature and glass transition temperature, T_{g}. To form a good coating, the polymer preferably has a film forming temperature lower than the operating temperatures inside the chamber of the drum coater in the coating process. A high T_{g} would lead to a brittle and fragile film which may easily peel off. Generally, a polymer with lower film forming temperature and T_{g} forms better film than those polymers with higher corresponding temperatures.

3. Good film forming ability onto tablet surface: In the early stage of the coating process, the polymer has to have good adherence to the tablet surface, so that the coating film can gradually build up. The polymer particles should pack well without large spaces or holes in between. This can be examined and confirmed under a microscope. Typically the polymer with small particle size will result in better packing. Also, the polymer must possess good elasticity; otherwise, the coating would crack, especially upon cooling.

4. Insolubility of the polymer in an operating aqueous system: Typically, an operating aqueous system, has high temperatures. For example, an operating open recirculating cooling water system is about 70 degrees F. to about 150 degrees F., preferably about 80 degrees F. to about 100 degrees F., more preferably about 90 degrees F. to about 95 degrees F. The polymer coatings should be able to remain insoluble and stable in these systems. If the polymer coating dissolves, it will lose the slow release function.

5. Stability of polymer coating in solutions of aqueous systems under operating conditions: Many polymers degrade because they undergo alkaline hydrolysis reactions in operating aqueous system conditions. As degradation or dissolution occurs, the coating is damaged. As a result, the coating forms holes and loses the control of slow release. Subsequently, all chemical ingredients rapidly enter the bulk cooling.

Without wishing to limit the invention to any particular mechanism or theory of operation, it is believed that the release of ingredients from the tablet core into the bulk cooling solution involves three steps:

(a) cooling solution enters the inner tablet core through the polymer coating, (b) chemical ingredients of the tablet dissolve in contact with cooling solution and (c) the resulting highly concentrated solution diffuses through the polymer coating back into the bulk cooling solution. The path and size of channels, microscopically, within the polymer coating, which are characteristics of each specific polymer and are closely related to the physical properties of each polymer in cooling solutions at elevated temperatures, control the kinetics of these actions.

In one embodiment, film forming polymers are found to have these desired properties. Suitable film forming polymers include, for example, homopolymers, copolymers and mixtures thereof, wherein the monomer units of the polymers are preferably derived from ethylenically unsaturated monomers, for example, two different such monomers.

A particularly useful ethylenically unsaturated monomer is compound I with the formula (R₁) (R₂) (R₃)C—COO—(CH═CH₂), wherein R₁, R₂ and R₃ are independently selected saturated alkyl chains. In one embodiment, R₃ of compound I is CH₃, and R₁ and R₂ of compound I have a total of about 2 to about 15 carbon. An example of such a material is known as a vinylversatate. In a preferred embodiment, R₃ is CH₃, and R₁ and R₂ have a total of about 5 to about 10 carbons. In a more preferred embodiment, R₃ is CH₃, and R₁ and R₂ have a total of 7 carbons.

In another embodiment, each of the R₁, R₂, and R₃ of compound I is an independently selected single chemical element. For example, the element may be halogen, preferably chlorine or chloride. More preferably, the element may be hydrogen. Compound I having hydrogens for R₁, R₂ and R₃ is known as vinylacetate.

In another embodiment, R₁ of compound I may be a single chemical element, and R₂ of compound I may be a saturated alkyl chain.

Other examples of ethylenically unsaturated monomers include, without limitation, monoolefinic hydrocarbons, i.e. monomers containing only carbon and hydrogen, including such materials as ethylene, alkylcellulose (for example, ethylcellulose), propylene, 3-methylbutene-1, 4-methylpentene-1, pentene-1, 3,3-dimethylbutene-1, 4,4-dimethylbutene-1, octene-1, decene-1, styrene and its nuclear, alpha-alkyl or aryl substituted derivatives, e.g., o-, or p-methyl, ethyl, propyl or butyl styrene, alpha-methyl, ethyl, propyl or butyl styrene; phenyl styrene, and halogenated styrenes such as alpha-chlorostyrene; monoolefinically unsaturated esters including vinyl esters, e.g., vinyl propionate, vinyl butyrate, vinyl stearate, vinyl benzoate, vinyl-p-chlorobenzoates, alkyl methacrylates, e.g., methyl, ethyl, propyl, butyl, octyl and lauryl methacrylate; alkyl crotonates, e.g., octyl; alkyl acrylates, e.g., methyl, ethyl, propyl, butyl, 2-ethylhexyl, stearyl, hydroxyethyl and tertiary butylamino acrylates, isopropenyl esters, e.g., isopropenyl acetate, isopropenyl propionate, isopropenyl butyrate and isopropenyl isobutyrate; isopropenyl halides, e.g., isopropenyl chloride; vinyl esters of halogenated acids, e.g., vinyl alpha-chloroacetate, vinyl alpha-chloropropionate and vinyl alpha-bromopropionate; allyl and methallyl compounds, e.g., allyl chloride, ally alcohol, allyl cyanide, allyl chlorocarbonate, allyl nitrate, allyl formate and allyl acetate and the corresponding methallyl compounds; esters of alkenyl alcohols, e.g., beta-ethyl allyl alcohol and beta-propyl allyl alcohol; halo-alkyl acrylates, e.g., methyl alpha-chloroacrylate, ethyl alpha-chloroacrylate, methyl alphabromoacrylate, ethyl alpha-bromoacrylate, methyl alpha-fluoroacrylate, ethyl alpha-fluoroacrylate, methyl alpha-iodoacrylate and ethyl alpha-iodoacrylate; alkyl alpha-cyanoacrylates, e.g., methyl alpha-cyanoacrylate and ethyl alpha-cyanoacrylate and maleates, e.g., monomethyl maleate, monoethyl maleate, dimethyl maleate, diethyl maleate; and fumarates, e.g., monomethyl fumarate, monoethyl fumarate, dimethyl fumarate, diethyl fumarate; and diethyl glutaconate; monoolefinically unsaturated organic nitriles including, for example, fumaronitrile, acrylonitrile, methacrylonitrile, ethacrylonitrile, 1,1-dicyanopropene-1, 3-octenonitrile, crotononitrile and oleonitrile; monoolefinically unsaturated carboxylic acids including, for example, acrylic acid, methacrylic acid, crotonic acid, 3-butenoic acid, cinnamic acid, maleic, fumaric and itaconic acids, maleic anhydride-and the like. Amides of these acids, such as acrylamide, are also useful. Vinyl alkyl ethers and vinyl ethers, e.g., vinyl methyl ether, vinyl ethyl ether, vinyl propyl ether, vinyl n-butyl ether, vinyl isobutyl ether, vinyl 2-ethylhexyl ether, vinyl-2-chloroethyl ether, vinyl propyl ether, vinyl n-butyl ether, vinyl isobutyl ether, vinyl-2-ethylhexyl ether, vinyl 2-chloroethyl ether, vinyl cetyl ether and the like; and vinyl sulfides, e.g., vinyl beta-chloroethyl sulfide, vinyl beta-ethoxyethyl sulfide and the like. Other useful ethylenically unsaturated monomers are styrene, methyl methacrylate, and methyl acrylate.

In one embodiment, the polymer forming the coating is made up of a copolymer, wherein the copolymer is made from units of vinylacetate and vinylversatate. In a preferred embodiment, about 45% to about 95% by weight of the units are from vinylacetate and about 5% to about 55% by weight of the units are from vinylversatate. In more preferred embodiment, about 65% by weight of the units are from vinylacetate and about 35% by weight of the units are from vinylversatate.

In one preferred embodiment, the vinylversatate used is sold under: the trademark VEOVA 10 sold by Shell Chemicals. In a particularly preferred embodiment, the water-based emulsion polymer is a vinylacetate-vinylversatate copolymer, sold under the trademark EMULTEX VV575 sold by Harlow Chemical Co. (England). Additionally, a surfactant may also be added to stabilize the dispersion. In a preferred embodiment, the polymer solid in the dispersion is about 54% to about 56% by weight of active polymer solid.

EMULTEX VV575 is particularly advantageous because it meets all of the six requirements for a good coating as set forth above. That is, it (1) exhibits a viscosity low enough for coating processing without difficulties, for example about 500 to about 1,500 mPa.s (RVT 2-20 at 23° C.), (2) has a film forming temperature of 10 degrees C. and a glass transition temperature, T_{g}, of 11 degrees C., low enough for forming a good coating, (3) has a fine to medium particle size of about 0.37 micron and forms an elastic coating, (4) is insoluble in coolants at operating conditions, (5) is stable in coolants at operating conditions and (6) gives excellent release rates for ingredients, for example, ingredients in DCA-4+ tablets. (DCA-4+ tablets are described in detail herein below.)

In one embodiment, a copolymer which may be used as a coating in accordance with this invention include acrylate-vinylversatate. NeoCAR 820 sold by Union Carbide is the preferred acrylate-vinylversatate copolymer used for forming coatings.

In one embodiment, a polymer forming a coating in accordance with this invention is made up of a copolymer, wherein the copolymer is made from units of vinylacetate and ethylene. In a preferred embodiment, about 45% to about 95% by weight of the units are from vinylacetate and about 5% to about 55% by weight of the units are from ethylene. In more preferred embodiment, about 60% to about 80% by weight of the units are from vinylacetate and about 30% to about 40% by weight of the units are from ethylene. In an even more preferred embodiment, about 90% by weight of the units are from vinylacetate and about 10% by weight of the units are from ethylene. A additive composition of the present invention may advantageously comprise about 5% to about 15% of a vinylacetate-ethylene copolymer.

In a preferred embodiment, a copolymer comprising vinylacetate and ethylene may be purchased under the trade name AirFlex 410, sold by Air Products and Chemicals, Inc., Allen Town, Pa., U.S.A. Such copolymer preferably has a viscosity of about 250 to about 900 cps.

In another embodiment, the polymer for coating is made up of a homopolymer. In a preferred embodiment, the monomer unit for forming the homopolymer is ethylcellulose. In a more preferred embodiment, ethylcellulose used for forming coatings is purchased from Dow Chemical sold under the trademark ETHOCEL S10, S20, S100, and preferably S45.

Specific properties of the various ETHOCEL's are determined by the number of anhydrous units in the polymer chain (expressed by the molecular weight or the solution viscosity), and, the degree of ethoxyl substitution (expressed as the percent of hydroxyl group, —OH, in cellulose substituted by ethoxyl group, —OC_{2 H}₅). The preferred ETHOCEL S45 has a solution viscosity of about 41 to about 49 cP and about 48 to about 49.9% ethoxyl content. The viscosity is for a 5% solution in 80/20 toluene/ethanol measured at 25 degrees C. in an Ubbelohde viscometer.

In one embodiment, the additive component comprises an additive. As used herein, the term “additive” includes all materials which can be compounded or admixed with the additive compositions and which impart beneficial properties to the aqueous system. For example, an additive may comprise a microbiocide that is compatible with aqueous systems. In one embodiment, the additive component comprises a mixture of conventional inhibiting and buffering agents typically used in aqueous systems, preferably cooling systems, more preferably open recirculating cooling water systems. In one embodiment, the additive component comprises (1) a buffering component to maintain a neutral or alkaline pH, including for example, alkali metal salts or sodium phosphates, borates and the like, (2) a cavitation liner pitting inhibitor component, including for example, alkali metal or sodium nitrites, molybdates and the like, (3) a metal corrosion and hot surface corrosion inhibitor component, including for example, alkali metal, salts of nitrates, nitrates and silicates, carboxylic acids, phosphonic acids, phosphonate, pyrophosphate, azoles, sulfonic acids, mercaptobenzothiazoles, metal dithiophosphates and metal dithiocarbonates (one particular corrosion inhibitor that has been found to be highly satisfactory and is preferred is a phenolic anti-oxidant, 4,4′-methylenebis (2,6-di-tertbutylphenol) that is commercially available under the trademark Ethyl 702 manufactured by Ethyl Corporation)., and the like, (4) a defoaming agent component including for example, silicone defoamers, alcohols such as polyethoxylated glycol, polypropoxylated glycol or acetylenic glycols and the like, (5) a hot surface deposition and scale inhibitor component including for example, phosphate esters, phosphino carboxylic acid, polyacrylates, styrene-maleic anhydride copolymers, sulfonates and the like, (6) a dispersing component, including for example, non-ionic and/or anionic surfactants such as phosphate esters, sodium alkyl sulfonates, sodium aryl sulfonates, sodium alkylaryl sulfonates, linear alkyl benzene sulfonates, alkylphenols, ethoxylated alcohols, carboxylic esters and the like, (7) an organic acid, including for example adipic acid, sebacic acid and the like, (8) an anti-gel such as that disclosed by Feldman et al in U.S. Pat. No. 5,094,666, the content of which is incorporated in its entirety herein by reference (for example, such anti-gel additive comprises copolymers of ethylene and vinyl esters of fatty acids with molecular weight of about 500-50,000; or Tallow amine salt of phthalic anhydride, used at 0.01-0.2%; or Tallow amine salt of dithio benzoic acid, used at 0.005-0.15%; or 4-hydroxy, 3,5-di-t-butyl dithiobenzoic acid; or ethylene-vinylacetate copolymers) and/or microbiocides, preferably microbiocides used in open recirculating cooling water systems of cooling towers, as disclosed by Sherbondy et al. U.S. Pat. No. 5,662,803, wherein the disclosures of which are incorporated in their entirety herein by reference.

In one embodiment, an additive component comprises one or more of the following: corrosion inhibitors, sodium Molybdate dihydrate, Benzotriazole/Tolytriazole, scale inhibitors, HEDP (1-Hydroxyethylidene-1,1-phosphonic acid) like those from Solutia, Dequest 2016-D, polyacrylate/acrylic acid polymers from Noveon-B F Goodrich, dispersants, sulfonated styrene maleic-anhydride, describing such systems is found in G. Santus and R. W. Baker, J. Control. Rel., 1995, 35, 1-21. releasing compounds and indicators.

For example, an additive component for use in the Midwest U.S. (based on ˜250 ppm dissolved solids in make-up) may comprise (by weight) about 20% of sodium molybdate dihydrate, about 20% of HEDP, about 30% of Narlex D-72, about 2% of benzotriazole and about 28% of a filler. Based on the above formula, a typical treatment level would be 50 ppm total.

Other additive components contain a mixture of one or more of the active provided in the following Table 1. The possible functions identified are intended to be exemplary, not limiting.

TABLE 1

| COMPONENT | POSSIBLE FUNCTION | RANGE % |
|---|---|---|
| Alkali metal or | corrosion inhibitor/ | 0-80 |
| Ammonium phosphates | buffering agent | |
| Alkali metal or | corrosion inhibitor/ | 0-80 |
| ammonium phosphonate | buffering agent | |
| Alkali metal or | corrosion inhibitor/ | 0-80 |
| ammonium pyrophosphate | buffering agent | |
| Alkali metal or | corrosion inhibitor/ | 0-80 |
| ammonium borate | buffering agent | |
| Alkali metal or | cavitation liner | 4-60 |
| ammonium nitrites | pitting/corrosion inhibitor | |
| Alkali metal or | cavitation liner | 4-60 |
| ammonium molybdates | pitting/corrosion inhibitor | |
| Alkali metal or | corrosion inhibitor | |
| ammonium nitrates | | |
| Alkali metal or | corrosion inhibitor | 0-40 |
| ammonium silicates | | |
| Alkali metal or | corrosion inhibitor | 1-15 |
| ammonium salts of one | | |
| or more neutralized | | |
| dicarboxylic acids | | |
| Tolyltriazole | corrosion inhibitor | 1-15 |
| Dispersants (e.g. | deposition and scale | 0-15 |
| polyacrylic acid, | | |
| phosphino carboxylic | | |
| acid, phosphate esters, | | |
| styrene-maleic anhydride | | |
| copolymers, polmaleic acid, | | |
| sufonates and sulfonate | | |
| copolymers) | | |
| Defoamers (e.g. silicones, | foam inhibitor | 0-3 |
| polyethoxylated glycol, | | |
| polypropoxylated glycol, | | |
| acteylenic glycols) | | |

In one embodiment, the additive component includes nitrite compounds. In a preferred embodiment, the additive component includes a mixture of nitrite compounds and molybdate compounds to maintain a minimum concentration level of about 800 ppm of nitrite or a mixture of nitrite and molybdate in the cooling system, with the proviso that the minimum level of nitrite in the cooling system is about 400 ppm. Such additive is sold by Fleetguard under the trademark DCA-2+, which includes borate, silicate, tolyltriazole, scale inhibitors, surfactants and defoamers, in addition to nitrite.

In a more preferable embodiment, the additive component includes a mixture of nitrite, nitrate and molybdate compounds. In a more preferred embodiment, the additive component comprises nitrite, nitrate, phosphate, silicate, borate, molybdate, tolyltriazole, organic acids, scale inhibitors, surfactants and defoamer. Such an additive is sold by Fleetguard under the trademark DCA-4+.

The additive component may be in solid, granular or particulate form provided that it does not decompose or melt at processing temperatures. Preferably, the additive component is molded in the form of a pellet or tablet which may have either a spherical or irregular shape. The additive pellet or tablet should be of sufficient size to provide the steady controlled release of the additive components into the cooling system over the desired period of time. Further, when the additive pellet or tablet is used in a filtering environment, it should be larger than the pores or orifices of the filter. Generally, a spherical pellet or tablet should have a diameter on the order of from about 1/32″ to about 5.0″, preferably from about 2/32″ to about 3″, more preferably from about ⅛″ to about ½″, even more preferably about ⅜″.

The formation of the additive component into a pellet or tablet is dependent upon the mixture of materials contained therein. For example, when the additive component contains a sufficient amount of a dispersing agent or a mixture of dispersing agents, the dispersing agent or mixture also may function as a binder, thereby allowing the component to be molded or compressed directly into the form of a pellet or tablet. If the additive component does not compact well, a binder must be added to the additive component in order to mold or compress it into a pellet or tablet. Suitable binders include, for example, polyvinyl pyrrolidone, sodium acrylate, sodium polyacrylate, carboxymethylcellulose, sodium carboxyinethylcellulose, corn starch, microcrystalline cellulose, propylene glycol, ethylene glycol, sodium silicate, potassium silicate, methacrylate/acrylate copolymers, sodium lignosulfonate, sodium hydroxypropylcellulose, preferably hydroxyethylcellulose, and water.

Preferably, the additive component to be molded or compressed into a pellet or tablet further comprises a die release agent. Suitable die release agents include, for example, calcium stearate, magnesium stearate, zinc stearate, stearic acid, propylene glycol, ethylene glycol, polyethylene glycol, polypropylene glycol, polyoxypropylene-polyoxyethylene block copolymers, microcrystalline cellulose, kaolin, attapulgite, magnesium carbonate, fumed silica, magnesium silicate, calcium silicate, silicones, mono-and dicarboxylic acids and corn starch.

To form a controlled release cooling additive composition, the polymeric coating may be applied to the additive composition core by spray coating, microencapsulation or any other coating technique well known to practitioners in the art. Preferably, the polymeric coating is an aqueous dispersion latex which is applied to the additive core pellet or tablet by drum or pan coating. The amount of coating to be applied to the additive core is dependent upon the desired controlled release characteristics of the resulting coated tablet or pellet. An increase in the amount of coating will result in a decrease of the rate of release of the additive component. Generally, the weight percent of the coating is from about 1.0 to about 40.0% based on the total weight of the additive tablet, preferably from about 2% to about 20% by weight even more preferably about 3% to about 15% by weight. For example, the coatings employed in a cooling tower are about 4% to about 10%, preferably about 8% by weight.

In one broad embodiment, a method is provided for maintaining an effective concentration of at least one additive component in an open recirculating cooling water system. The method includes steps of placing the additive composition, such as the ones described herein, in contact with the cooling water in an open recirculating cooling water system. For example, the additive compositions may be placed in containers which are fluidly connected to the make-up line. As the make-up fluid from the make-up line enters the container and mixes with the additive composition, the additive composition releases additives into the make-up fluid. The make-up fluid then carries the additives into the open recirculating system.

In one embodiment, methods for providing controlled release of additives to an open recirculating system may be practiced using the liquid replacement systems described herein. In one embodiment, methods for providing controlled release of additives to an open recirculating system may be practiced using the make-up line described herein. These methods preferably are pump-free and/or monitor free.

The following non-limiting examples illustrate certain aspects of the present invention.

### EXAMPLE 1

### Release Characteristics of a Controlled Release Cooling Additive Composition in a Flask

The release characteristics of a controlled release cooling additive composition were tested in a flask. In particular, the coating used for the cooling additive composition tested was vinylacetate-vinylversatate copolymer(EMULTEX VV575) and the additive component used was DCA-4+ additive composition. The finished tablet, weighing about 1.462 grams on the average, is of about 11 mm diameter and contains 26.8% by weight of EMULTEX VV575 copolymer solid. The test cooling solution was prepared by mixing equal volume of ethylene glycol and de-ionized water. It also contains potassium phosphate K₂HPO₄ at 2,000 mg/L concentration. The pH of the test solution was adjusted to 10.3 with sodium hydroxide.

Five coated tablets were stacked inside a polypropylene tube of 92 mm in length, and 14 mm in diameter. The tube, with one side open, has a total of 18 holes distributed evenly around the wall and one hole on the bottom of the tube. Each hole has a diameter of 4 mm.

The tube with the coated tablets was hung inside a 3-neck, 1-Liter, flask equipped with a magnetic stir bar and a cold-water condenser. Then, the flask was filled with 0.900 liters of test cooling solution.

Subsequently, with mixing, the solution was heated to, and kept at, 190±3 degrees F. The release of chemical ingredients from the DCA-4+ tablets into the solution was monitored. Samples were taken and analyzed for nitrite, nitrate and molybdate. The percent release with time for each ingredient was calculated as the ratio of measured concentration and expected concentration at full release. The results are shown as percent release with time in Table 2.

TABLE 2

| HOURS | NITRITE | NITRATE | MOLYBDATE |
|---|---|---|---|
| 43 | 0 | 0 | 0 |
| 90 | 11.4 | 11.3 | 8.9 |
| 162 | 14.0 | 14.2 | 10.2 |
| 215 | 21.3 | 21.1 | 18.1 |
| 258 | 29.1 | 29.1 | 25.1 |
| 330 | 41.7 | 40.2 | 31.5 |
| 402 | 53.1 | 55.6 | 41.1 |
| 498 | 70.3 | 62.9 | 59.8 |
| 598 | 77.8 | 79.6 | 62.9 |
| 666 | 89.7 | 94.0 | 72.0 |
| 763 | 94.4 | 95.8 | 76.6 |
| 835 | 101* | 105* | 81.0 |
| 931 | 105* | 104* | 87.2 |

*Release factor greater than 100% was due to statistical variations in concentration measurements.

As the data indicate, the ingredients were released gradually with time from the inner DCA-4+ tablet core into the outside test solution. An effective and substantially complete release was reached for nitrite and nitrate at approximately 800 hours, and for molybdate, expectedly, at approximately 1,100 hours.

Using the same flask protocol and conditions as described above, other cooling additive compositions were tested. Table 3 shows the slow release data (% release) for EMULEX VV575 at 22.3% coating on DCA-4+ tablets. Table 4 shows the slow release data (% release) for EMULEX VV575 at 18.2% coating on DCA-4+ tablets. Table 5 shows the slow release data (% release) for NeoCAR 820 (an acrylate-vinylversatate copolymer) at 30% coating on DCA-4+ tablets. Table 6 shows the slow release data (% release) for ETHOCEL S45 at 5% coating on DCA-4+ tablets. Table 7 shows the slow release data of ETHOCEL S45 at 15% coating on DCA-4+ tablets.

These data indicate that the ingredients were released gradually with time from the inner DCA-4+ tablet core into the outside test solution. Furthermore, as expected, the release rates for the additives are inversely proportional to the percentages of coating, i.e., coating by EMULEX VV575 at 26.8% (Table 2) has slower release rates of the additive components than at 22.3% (Table 3) and 18.2% (Table 4), respectively. Also, with the ETHOCEL polymer, the release rates for the additives are shown to be inversely proportional to the percentages of coating (Tables 6 and 7).

TABLE 3

| HOURS | NITRITE | NITRATE | MOLYBDATE |
|---|---|---|---|
| 43 | 0 | 0 | 0 |
| 90 | 9.9 | 9.4 | 8.0 |
| 162 | 19.8 | 22.3 | 17.2 |
| 215 | 43.6 | 46.5 | 38.3 |
| 258 | 49.4 | 49.8 | 39.2 |
| 330 | 69.2 | 72.3 | 59.5 |
| 402 | 91.3 | 91.5 | 75.8 |
| 498 | 102.0* | 98.3 | 80.9 |
| 598 | 99.1 | 99.1 | 83.4 |

*Release factor greater than 100% was due to statistical variations in concentration measurements.

TABLE 4

| HOURS | NITRITE | NITRATE | MOLYBDATE |
|---|---|---|---|
| 43 | 14.4 | 14.7 | 12.2 |
| 90 | 54.3 | 55.1 | 41.1 |
| 162 | 84.2 | 81.8 | 67.2 |
| 258 | 101* | 102* | 84.1 |

*Release factor greater than 100% was due to statistical variations in concentration measurements.

TABLE 5

| HOURS | NITRITE | NITRATE | MOLYBDATE |
|---|---|---|---|
| 43 | 0 | 0 | 0 |
| 90 | 0 | 0 | 0 |
| 162 | 0 | 2.4 | 0 |
| 215 | 0.7 | 3.5 | 2.2 |
| 258 | 8.7 | 9.6 | 8.3 |
| 330 | 10.6 | 11.8 | 9.8 |
| 402 | 12.2 | 13.1 | 11.2 |
| 498 | 22.5 | 21.8 | 21.0 |
| 598 | 28.5 | 29.0 | 25.4 |
| 666 | 30.6 | 30.1 | 27.1 |
| 788 | 34.9 | 34.9 | 31.3 |
| 835 | 36.0 | 41.9 | 35.4 |
| 931 | 38.0 | 43.9 | 36.0 |
| 1002 | 38.9 | 44.8 | 36.3 |

TABLE 6

| HOURS | NITRITE | NITRATE | MOLYBDATE |
|---|---|---|---|
| 66 | 62.6 | 57.0 | 41.2 |
| 162 | 76.5 | 67.5 | 48.1 |
| 216 | 81.3 | 73.9 | 53.3 |
| 429 | 86.1 | 79.2 | 56.4 |
| 525 | 90.0 | 82.5 | 58.1 |
| 602 | 92.7 | 85.8 | 61.2 |

TABLE 7

| HOURS | NITRITE | NITRATE | MOLYBDATE |
|---|---|---|---|
| 28 | 1.0 | 6.7 | 0 |
| 71 | 25.0 | 25.8 | 17.8 |
| 143 | 45.8 | 49.5 | 38.0 |
| 244 | 53.7 | 57.2 | 48.5 |
| 407 | 62.4 | 69.1 | 57.2 |
| 479 | 72.5 | 74.4 | 71.8 |
| 579 | 74.2 | 79.3 | 72.7 |
| 743 | 79.6 | 84.1 | 76.5 |
| 892 | 80.8 | 84.6 | 80.1 |
| 1012 | 88.8 | 90.6 | 83.3 |

### EXAMPLE 2

### Release Characteristics of a Controlled Release Cooling Additive Composition on a Rig

In one embodiment, the additive compositions may be used in an engine cooling system. Therefore, the performance of the additive compositions were tested on a rig, which simulates an engine cooling system. For example, the performance of vinylacetate-vinylversatate (EMULTEX VV575), as a coating for DCA-4+ tablet, a cooling additive, was tested on a rig to simulate an engine cooling system. DCA-4+ tablets coated with 26.8% of EMULTEX VV575 were tested. The rig has three major components: a reservoir tank, a radiator and a pump. A heating element was installed inside the tank. In the experiment, a total of 18.4 liters of test cooling solution was added into the system. This system is similar to that of the one disclosed by Mitchell et al in U.S. Pat. No. 6,010,639, the disclosure of which is incorporated in its entirety by reference herein.

A Fleetguard WF2121 filter was used for the study. It contained a total of 187 pieces of coated DCA-4+ inside the center tube of the filter.

After the filter was screwed onto the test rig between the reservoir and the radiator, the pump was started to begin the experiment as the test solution was circulated throughout the system. The flow rate of test solution through the filter was kept at about 1.2 to about 1.5 gallons per minute and the temperature of the bulk test solution was kept at about 190±5 degrees F. After every 10 days of running, the system was shut off for 12-48 hours before it was restarted.

Samples were collected with time, analyzed and the percent release of ingredients was calculated, similarly to the experiment in the flask above. Table 3 shows the percent release of the additives with time in a rig.

TABLE 8

| HOURS | NITRITE | NITRATE | MOLYBDATE |
|---|---|---|---|
| 43 | 0.5 | 2.1 | 1.2 |
| 90 | 1.6 | 2.1 | 1.9 |
| 162 | 4.2 | 4.9 | 3.7 |
| 215 | 6.1 | 6.2 | 5.2 |
| 260 | 7.8 | 7.6 | 6.5 |
| 354 | 12.3 | 11.6 | 9.4 |
| 402 | 13.2 | 12.9 | 10.0 |
| 498 | 16.0 | 13.7 | 12.1 |
| 598 | 18.7 | 16.1 | 14.4 |
| 666 | 20.2 | 18.3 | 15.4 |
| 714 | 23.9 | 21.3 | 18.4 |
| 790 | 26.3 | 27.2 | 21.2 |
| 835 | 31.9 | 31.6 | 26.2 |
| 931 | 35.2 | 37.1 | 29.7 |
| 1000 | 43.3 | 44.1 | 35.2 |
| 1100 | 56.3 | 58.1 | 47.5 |
| 1192 | 69.8 | 74.1 | 57.6 |
| 1290 | 77.0 | 82.1 | 64.7 |
| 1390 | 82.0 | 82.4 | 67.7 |
| 1552 | 84.1 | 84.4 | 69.8 |
| 1720 | 89.4 | 95.0 | 75.0 |
| 1985 | 92.3 | 95.3 | 75.3 |

Again, as the data demonstrate, the ingredients were released gradually from the inner DCA-4+ tablet core into the outside test cooling solution. The release rate was significantly slower for every ingredient compared to that from the experiment in the flask.

The following example provides those of ordinary skill in the art with specific methods to produce the controlled release cooling additive composition within the scope of the present invention and is not intended to limit the scope of the invention.

### EXAMPLE 3

### Method for Making the Controlled Release Cooling Additive Composition

Fleetguard DCA-4+ tablets were used. They are composed of nitrite, nitrate, phosphate, silicate, borate, molybdate, tolyltriazole, organic acid, scale inhibitors, surfactants and defoamers. The powdery ingredients were mixed first, then pressed into standard-cup tablets using ⅜″ tooling. The tablets were of about 1.10 grams in weight and about 8 to about 15 kps in hardness. The Drum Coater was used for coating.

For coating the DCA-4+ tablets, the DCA-4+ standard-cup tablets were placed onto the rotating pan inside the drum coater. While the pan was being rotated, EMULTEX VV575 dispersion was pumped and sprayed through a nozzle onto the tablet surface. The spray rate is important. It was maintained at about 15 grams of dispersion per minute. The spray pattern was controlled to give a good mist of polymer droplets.

At the same time, through a very slightly reduced pressure, a stream of warm air of about 40 degrees C. was passed through the coating chamber to remove the water vapor from the polymer mist (or small droplets), before and after they reached the tablet surface.

With time, the polymer gradually formed a layer of coating on the tablet. After all polymer dispersion was sprayed to reach the desired thickness of coating, the resulting coated tablets were allowed to stay on the rotating pan for a few more minutes, then were decanted from the pan into container for storage.

Various patents and references have been cited herein. The disclosures of these patents and references are incorporated in their entirety herein by reference.

While this invention has been described with respect to various specific examples and embodiments, it is to be understood that the invention is not limited thereto and that it can be variously practiced with the scope of the following claims.

What is claimed is:

1. A liquid replacement system for providing additives to an open recirculating cooling water system or a closed loop boiler water system, the liquid replacement system comprises a make-up line structured and positioned to allow a make-up liquid to enter therein and an additive system, including an additive component, disposed therein, the additive system being structured to provide a controlled release of the additive component to the make-up liquid passing through the make-up line, the make-up liquid carries the additive component into the open recirculating cooling water system or a closed loop boiler water system.

2. The liquid replacement system of claim 1 wherein the make-up line fluidly connects with a source line such that the make-up liquid flows from the source line and at least a fraction of the make-up liquid enters into the make-up line.

3. The liquid replacement system of claim 2 wherein the fraction of the make-up liquid passing through the make-up line is controlled by a valve.

4. The liquid replacement system of claim 2 wherein the fraction of the make-up liquid passing through the make-up line is controlled by a valve located in the make-up line.

5. The liquid replacement system of claim 2 wherein less than about 50% of the make-up liquid originating from the source line enters into the make-up line.

6. The liquid replacement system of claim 2 wherein less than about 10% of the make-up liquid originating from the source line enter into the make-up line.

7. The liquid replacement system of claim 2 wherein a flow rate of the make-up liquid flowing through the make-up line is slower than the flow rate of the make-up liquid flowing through the source line.

8. The liquid replacement system of claim 1 further comprising a source line and at least one additional make-up line, the source line fluidly connects with the make-up line and the additional make-up line, the make-up liquid passes from the source line and enters into at least one of the make-up line and the additional make-up line.

9. The liquid replacement system of claim 8 wherein the additional make-up line comprises an additional additive system disposed therein.

10. The liquid replacement system of claim 8 wherein the additional make-up line has no additive system disposed therein.

11. The liquid replacement system of claim 8 wherein the make-up liquid passing through the make-up line and the additional make-up line is controlled by a valve.

12. The liquid replacement system of claim 8 wherein the make-up liquid passing through the make-up line and the additional make-up line is controlled by a valve located in each of the make-up line and the additional make-up line, respectively.

13. The liquid replacement system of claim 8 wherein less than about 50% of the flow of the make-up liquid originating from the source line enter into the make-up line.

14. The liquid replacement system of claim 8 wherein less than about 10% of the flow of the make-up liquid originating from the source line enter into the make-up line.

15. The liquid replacement system of claim 8 wherein a flow rate of the make-up liquid flowing through the make-up line is slower than the flow rate of the make-up liquid flowing through the source line.

16. The liquid replacement system of claim 8 wherein less than about 50% of the flow of the make-up liquid originating from the source line enter into the additional make-up line.

17. The liquid replacement system of claim 8 wherein less than about 90% flow of the make-up liquid originating from the source line enter into the additional make-up line.

18. The liquid replacement system of claim 8 wherein a flow rate of the make-up liquid flowing through the additional make-up line is slower than the flow rate of the make-up liquid flowing through the source line.

19. The liquid replacement system of claim 1 wherein the additive system comprises a container having an additive composition therein, the container is structured to allow for the make-up liquid to come into contact with the additive composition.

20. The liquid replacement system of claim 19 wherein the additive composition comprises a controlled release component and the additive component, the controlled release component provides for controlled release of the additive component.

21. The liquid replacement system of claim 19 wherein the additive composition comprises
a core comprising the additive component; and
a controlled release component substantially surrounding the core.

22. The liquid replacement system of claim 20 wherein the controlled release component includes copolymers made from units of two monomers.

23. The liquid replacement system of claim 20 wherein the controlled release component includes copolymers made from units of vinylversatate and an ethylenically unsaturated monomer.

24. The liquid replacement system of claim 23 wherein the ethylenically unsaturated monomer is selected from the group consisting of vinylversatate and acrylate.

25. The liquid replacement system of claim 20 wherein the controlled release component includes copolymers made from units of vinylacetate and vinylversatate.

26. The liquid replacement system of claim 20 wherein the controlled release component includes copolymers made from units of vinylacetate and an ethylene.

27. The liquid replacement system of claim 20 wherein the controlled release component includes polymers made from up of about 45% to about 95% by weight of the units of vinylacetate and about 5% to about 55% by weight of the units of an ethylenically unsaturated monomer.

28. The liquid replacement system of claim 20 wherein the controlled release component includes polymers made from units of alkylcellulose.

29. The liquid replacement system of claim 20 wherein the additive component comprises at least one active ingredient selected from the group consisting of phosphonates, pyrophosphates, microbiocides buffering components, cavitation liner pitting inhibitors, metal corrosion and hot surface corrosion inhibitors, defoaming agents, hot surface deposition and scale inhibitors, dispersant agents, organic acids, surfactants and mixtures thereof.

30. A liquid replacement system for providing additives to an open recirculating cooling water system or a closed loop boiler water system, the liquid replacement system comprises a source line, a first make-up line, a second make-up line and an additive system, including a additive component, disposed in the finish make-up line; the source line fluidly connects with the finish make-up line and the second make-up line; the make-up liquid passes from the source line and enters into at least one of the first make-up line and the second make-up line; the additive system is structured to provide a controlled release of the additive component to the make-up liquid passing through the first make-up line which carries the additive component into the open recirculating system or the closed loop boiler water system.

31. A liquid replacement system comprising a make-up line and an additive system disposed therein, the make-up line is for use for providing additives to an open recirculating system or a closed loop boiler water system.

32. The liquid replacement system of claim 31 wherein the make-up line fluidly connects with a source line, wherein a make-up liquid originates from the source line and at least a fraction of the make-up liquid enters into the make-up line.

33. The liquid replacement system of claim 31 wherein the additive system comprises a container having an additive composition therein, the container is structured to allow for the make-up liquid to come into contact with the additive composition.

34. The liquid replacement system of claim 33 wherein the additive composition comprises a controlled release component and an additive component, the controlled release component provides for controlled release of the additive component.

35. The liquid replacement system of claim 33 wherein the additive composition comprises
a core comprising the additive component; and
a controlled release component substantially surrounding the core.

36. A method for providing a controlled release of additives into an open recirculating system or a closed loop boiler water system, the method comprises the step of passing a make-up liquid through a make-up line, the make-up line comprises an additive system disposed therein, the make-up liquid passing through the make-up line ultimately feeds into the open recirculating system or the closed loop boiler water system.

37. The method of claim 36 wherein the additive system comprises a container having an additive composition therein, the container is structured to allow for the make-up liquid to come into contact with the additive composition.

38. The method of claim 36 wherein the additive composition comprises a controlled release component and an additive component, the controlled release component provides for controlled release of the additive component.

39. The method of claim 36 wherein the additive composition comprises
a core comprising the additive component; and
a controlled release component substantially surrounding the core.
